(19) United States
(12) Patent Application Publication
(10) Pub. No.: US 2021/0310813 A1
(43) Pub. Date: Oct. 7, 2021

(54) MAP INFORMATION COLLECTION AND ANALYSIS DEVICE FOR THE DISABLED

(71) Applicant: Amuse Travel Co., Ltd., Seoul (KR)

(72) Inventors: Seo Yeon OH, Seoul (KR); Chan Joong KIM, Goyang-si (KR)

(73) Assignee: Amuse Travel Co., Ltd., Seoul (KR)

(21) Appl. No.: 16/897,247

(22) Filed: Jun. 9, 2020

(30) Foreign Application Priority Data
Apr. 7, 2020 (KR) 10-2020-0042320

(51) Int. Cl. G01C 21/32; G01C 21/34; G01C 21/36; H04W 4/024; H04W 4/029

(52) U.S. Cl. CPC G01C 21/32; G01C 21/3476; H04W 4/029; H04W 4/024; G01C 21/3647

(57) ABSTRACT

The present disclosure classifies map information for the disabled received from each user terminal through a user interface into image information, current location information, and slope information, matches the classified image information and the current location on the basis of same time, grasps and determines a movement path of a corresponding user terminal by tracking the current location information on the basis of time, calculates a movement distance using the current location information and then calculates a slope per set unit distance using the movement distance and the slope information, determines a walking level using the slope per set unit distance, grasps a POI of a place where a user is currently positioned by applying the current location information to map information of a database, and generates disabled path information using the movement distance, image information on the movement path, and the walking level.

### CROSS-REFERENCE TO RELATED APPLICATIONS

This application claims the benefit of Korean Application No. 10-2020-0042320, filed Apr. 7, 2020, in the Korean Intellectual Property Office. All disclosures of the document named above are incorporated herein by reference.

### BACKGROUND OF THE INVENTION

### Field of the Invention

The present disclosure relates to a device for collecting and analyzing map information for the disabled and, more particularly, to a map information collection and analysis device for the disabled which collects walking information for the mobility handicapped such as old people and pregnant women by collecting and analyzing information provided from a mobile terminal of an information provider, and analyzes, process, and provide the walking information into information that can be used for making a map for the disabled.

### Related Art

As societies are advanced, there is an increasing demand for a smart city that solves various problems such as problems with the traffic and energy by efficiently managing the infrastructures of the city such as roads, harbors, waterworks, and schools and collecting and using public data.

As a part of constructing the smart city, an interest in the mobility handicapped such as the disabled, old people, and pregnant women is increased, and the interest spreads to various fields such as the policies of the government and the supporting programs of companies.

As one of these interests, at present, there is an effort to make a map for the mobility handicapped, and a technology of showing optimal paths to destination is provided to the mobility handicapped. Such a technology of the related art provides only the function of showing facilities for the mobility handicapped (including the disabled) or obstacles against walking on a map.

However, it is required to collect actual walking information on the side of the mobility handicapped about buildings or public facilities in order to provide optimal paths to destinations to the mobility handicapped or make a map for the mobility handicapped. Further, it is required to immediately reflect the facilities for the mobility handicapped or obstacle facilities that are changed momentarily.

### PRIOR ART DOCUMENT

### Patent Document

Korean Patent No. 10-1809596 (Registration Date: 2017 Dec. 11)
Japanese Patent No. 3056754 (Registration Date: 1998 Dec. 9)

### SUMMARY OF THE INVENTION

An object of the present disclosure is to provide a map information collection and analysis device for the disabled that can make a map for the mobility handicapped (hereafter, referred to as a “map for the disabled”) by collecting and analyzing actual walking information in real time facilities for the mobility handicapped or obstacle facilities that are changed momentarily on the side of the mobility handicapped in relation to building or public facilities by applying the concept of a living lab.

The present disclosure is not limited to the object and other objects may be inferred from the following embodiments.

In order to achieved the objects, an embodiment of the present disclosure provides a map information collection and analysis device for the disabled that includes: a user interface functioning as a communication interface with a user; an information collecting unit collecting map information for the disabled received from each user terminal through the user interface; an information classification unit classifying the map information for the disabled into image information, current location information, and slope information; an image processing unit matching the image information and the current location received from the information classifying unit on the basis of same time; a path determination unit grasping and determining a movement path of a corresponding user terminal by tracking the current location information received from the information classification unit on the basis of time; a slope grasping unit calculating a movement distance using the current location information received from the information classifying unit, and calculating a slope per set unit distance using the calculated movement distance and slope information received from the information classifying unit; a walking convenience analysis unit determining a walking level using the slope per set unit distance received from the slope grasping unit; and a map information generating unit grasping a POI of a place where a user is currently positioned by applying the received current location information to map information of a database, and generating disabled path information using a first path received from the path determination unit, a first image received from the image processing unit, and the walking level received from the slope grasping unit, in which the map information for the disabled is information provided from one user terminal and includes slope information measured by a slope sensor of the user terminal, image information photographed by a camera of the user terminal, and current location information measured by a GPS device of the user terminal.

The walking convenience analysis unit determines a wheelchair available level when the slope per set unit distance is less than a first angle. The walking convenience analysis unit determines a caution level requiring attention to moving a wheelchair when the slope per set unit distance is the first angle or more. In addition, the walking convenience analysis unit determines a wheelchair unavailable level when the slope per set unit distance is a second angle or more that is larger than the first angle.

The map information generating unit determines the first path as a valid walking path when all of a plurality of slopes per set unit distance included in the first path are less than the first angle.

The information collecting unit performs an information collection operation for a first user terminal by operating when current location information is initially received from the first user terminal, and stops the information collection operation for the first user terminal when current location information is not received from the first user terminal.

Alternatively, the information collecting unit performs an information collection operation for a first user terminal when an information transmission start order is received from the first user terminal, and stops the information collection operation for the first user terminal when an information transmission end order is received from the first user terminal.

### SUMMARY OF THE INVENTION

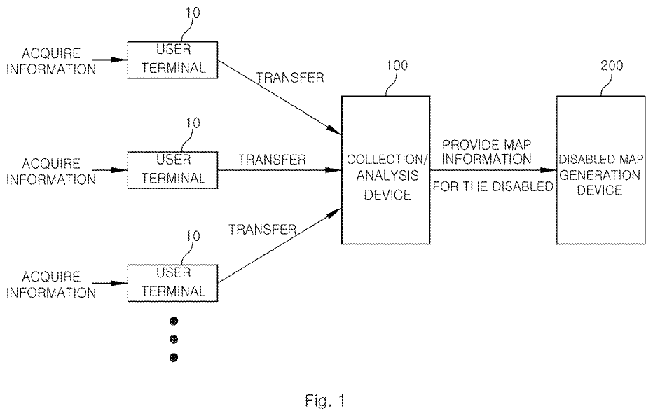

FIG. 1 is a diagram showing a network environment of a map information collection and analysis device for the disabled according to an embodiment of the present disclosure.

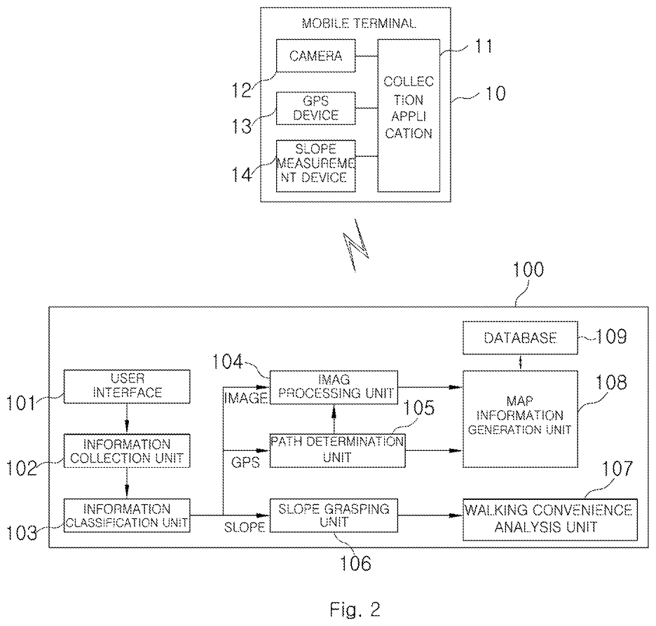

FIG. 2 is a block diagram of the map information collection and analysis device for the disabled according to an embodiment of the present disclosure.

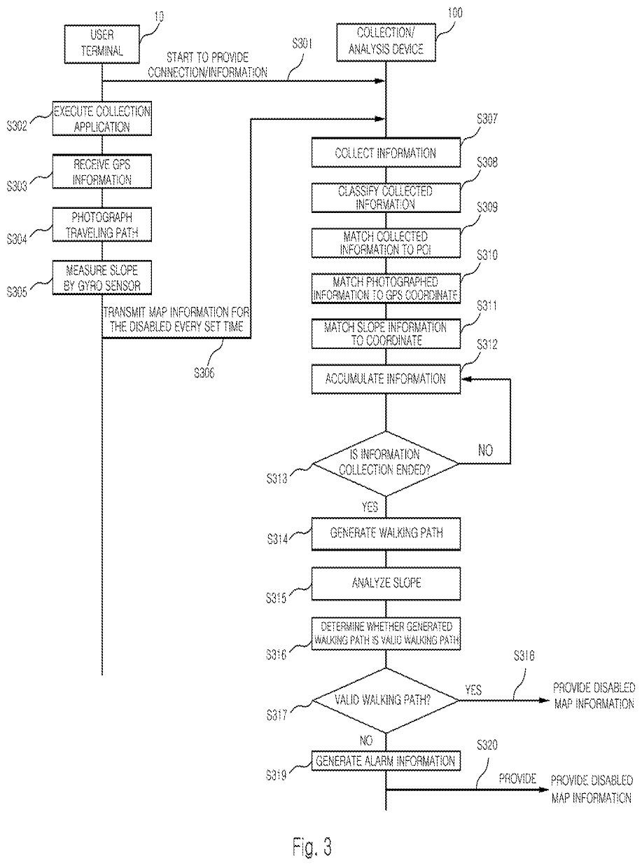

FIG. 3 is a flowchart showing the general operation of the map information collection and analysis device for the disabled according to an embodiment of the present disclosure.

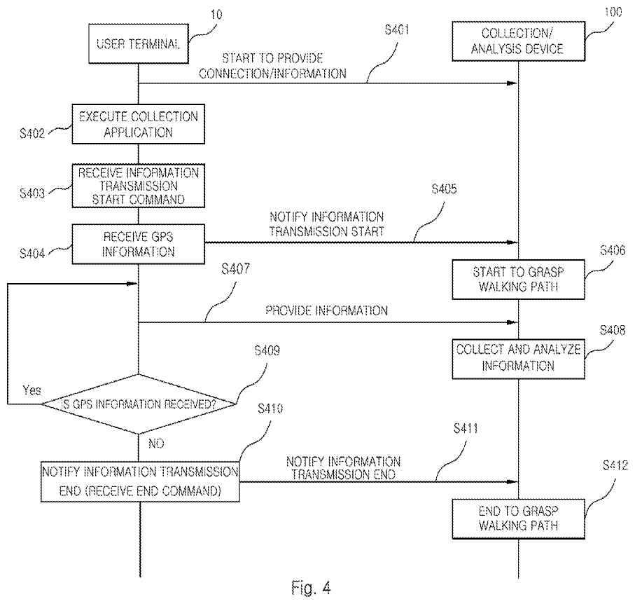

FIG. 4 is a flowchart showing an operation method of the map information collection and analysis device for the disabled according to a first embodiment of the present disclosure.

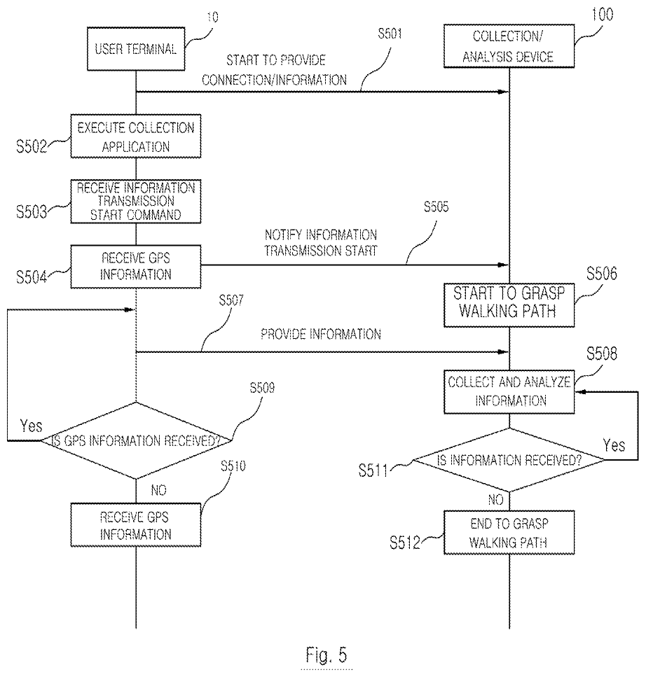

FIG. 5 is a flowchart showing an operation method of the map information collection and analysis device for the disabled according to a second embodiment of the present disclosure.

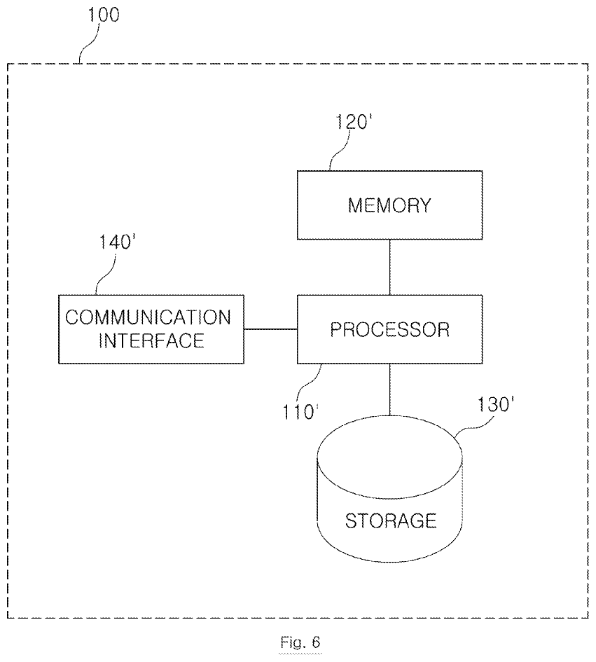

FIG. 6 is a diagram showing the hardware configuration of the map information collection and analysis device for the disabled according to an embodiment of the present disclosure.

### DESCRIPTION OF EXEMPLARY EMBODIMENTS

Hereafter, some embodiments will describe clearly and in detail with reference to the accompanying drawings so that those who have common knowledge in the art (skilled in the art) can easily achieve the present disclosure. Further, the term “unit” used herein may mean a hardware component or a circuit.

Hereafter, a map information collection and analysis device for the disabled according to an embodiment of the present disclosure is described with reference to the accompanying drawings.

Before description, map information for the disabled according to an embodiment of the present disclosure means fundamental information for first information that is shown on a map for the mobility handicapped such as the disabled, old people, and pregnant women. For example, map information for the disabled includes current location information (GPS coordinates), slope information at the current location, image information at the current location, etc. Further, the first information is, for example, path information, and image information, slope information, a walking level, etc. at the current location in the path, and the walking level is a wheelchair available level, a wheelchair unavailable level, a caution level, etc.

Determining the walking level is based on the slope of a path, and whether there is a moving assistant device such as a rail or a handle, whether a road is damaged, whether the rotational radius of a wheelchair can be secured, whether there is a dangerous element around, etc. The slope of a path is the slope per set unit distance and the unit distance may be 1 m, 5 m, 10 m, etc.

FIG. 1 is a diagram showing a network environment of a map information collection and analysis device for the disabled according to an embodiment of the present disclosure. Referring to FIG. 1, a network environment of a map information collection and analysis device 100 for the disabled according to an embodiment of the present disclosure includes a user terminal 10, a map information collection and analysis device 100 for the disabled (hereafter, referred to as a “collection/analysis device”), and a disabled map generation device 200.

The user terminal 10 is a terminal that can connect with the internet, can measure a current location, can measure and photograph a slope at the current location, and can be carried. For example, the user terminal 10 is a mobile, a notebook, a tablet PC, etc. The user terminal 10 has a collection application (application for collection) provided by the collection/analysis device 100 and installed therein, and connects with the collection/analysis device 100 and transmits acquired information to the collection/analysis device 100 through the collection application.

The collection/analysis device 100 is a device or an internet server that collects information (i.e., fundamental data for first information) received from several user terminals 10, generates first information that is map information for the disabled by analyzing and processing the collected information, and provides the first information to the disabled map generation device 200.

The disabled map generation device 200 is a device or an internet server that receives the first information that is map information for the disabled provided from the collection/analysis device 100, and generates a disabled map by showing the received first information on an existing map.

Hereafter, the collection/analysis device 100 according to an embodiment of the present disclosure is described in more detail.

FIG. 2 is a block diagram of the map information collection and analysis device for the disabled according to an embodiment of the present disclosure. Referring to FIG. 2, a collection application 11, which is a mobile app connecting with the collection/analysis device 100, acquiring map information for the disabled, and transferring the acquired map information for the disabled to the collection/analysis device 100, is installed in the user terminal 10. The collection application 11 acquires map information for the disabled in cooperation with a camera 12, a GPS device, and a slope measurement device 14 mounted in the user terminal 10. For example, the collection application 11 acquires image information from the camera 12, acquires current location information (GPS coordinates) from the GPS device 13, and acquires slope information through the slope measurement device 14. The slope measurement device 14 may be a gyro sensor or a slope sensor.

The collection/analysis device 100 according to an embodiment of the present disclosure includes a user interface 101, a information collecting unit 102, an information classification unit 103, an image processing unit 104, a path determination unit 105, a slope grasping unit 106, walking convenience analysis unit 107, a map information generating unit 108, and a database 109. The database 109 may be implemented as an individual device from the collection/analysis device 100 according to an embodiment of the present disclosure.

The user interface 101 functions as a communication interface with the user terminal 10. The information collecting unit 102 collects map information for the disabled received from each user terminal 10 through the user interface 101. The information classification unit 103 classifies the received map information for the disabled into image information, current location information, and slope information, provides the image information to the image processing unit 104, provides the current location information to the image processing unit 104 and the path determination unit 105, and provides the slope information to the slope grasping unit 106. Time at which corresponding information is acquired is included in the current location information, the slope information, and the image information.

The image processing unit 104 matches the image information received from the information classification unit 103 and the current location on the basis of the same time. The path determination unit 105 grasps and determines a movement path of a user by tracking the received current location information, that is, the GPS coordinates on the basis of time. The path determination unit 105 provides the determined path to the map information generating unit 108.

The slope grasping unit 106 receives the slope information and the current location information, calculates a movement distance using the current location information, and calculates a set movement distance, that is, a slope per set unit distance, that is, a slope.

The walking convenience analysis unit 107 determines a walking level using the slope per set unit distance received from the slope grasping unit 106. For example, the walking convenience analysis unit 107 determines a wheelchair available level when the slope per set unit distance is less than a first angle, determines a caution level requiring attention to moving a wheelchair when it is the first angle or more, and determines a wheelchair unavailable level when it is a second angle or more.

Further, when the slope per set unit distance shows a slope pattern, which is shown when moving on steps, in a predetermined period, that is, when a pattern having a period with a predetermined slope and a period without a slope, which are repeatedly shown, is shown, the walking convenience analysis unit 107 determines an obstacle or steps, determines the wheelchair unavailable level, and informs the map information generating unit 108 of an “obstacle”.

The map information generating unit 108 grasps a POI (Point Of Interest) of the place where a user is current positioned by applying the received current location information to the map information of the database 109. Further, the map information generating unit 108 receives a first path from the path determination unit 105, receives an image matched with the current location information through the image processing unit 104, and receives the walking level matched with the current location information from the slope grasping unit 106. Then, the map information generating unit 108 generates disabled path information obtained by matching the same current location information, image, and walking level for each current location information in the first path.

Obviously, display of an “obstacle” based on the current location information may be included in the disabled path information. When the disabled path information is generated in this way, the map information generating unit 108 generates map information by matching the POI and the disabled path information, and provides the generated map information to the disabled map generation device 200.

Meanwhile, matching with the POI may be performed by the path determination unit 105, and in this case, the information that is matched to the POI is the first path.

Further, the map information generating unit 108 determines a valid walking path when even any one of a disabled unavailable level and a caution level of the walking levels included in the disabled path information is not included, determines a dangerous walking path when even any one of the unavailable level and the caution level.

FIG. 3 is a flowchart showing the general operation of the map information collection and analysis device for the disabled according to an embodiment of the present disclosure. Referring to FIG. 3, a user positioned outside a specific building or public facility executes the collection application in his/her user terminal 10 to provide information about a path for entering the building or public facility to the collection/analysis device 100 (S301).

Accordingly, the user terminal 10 connects with the collection/analysis device 100 and gives a notice of starting to provide information (S302). Starting to provide information may be performed by only connecting with the collection/analysis device 100 through the collection application 11 or by only a user separately giving a notice of starting to provide information through the collection application 11.

When information is started to be provided, the collection application 11 acquires GPS information by operating the GPS device 12 (S303), acquires a corresponding image by driving the camera 12 to photograph the front or the surrounding of a traveling path (S304), and acquires a measured slope by measuring a slope at the current location by driving the slope measurement device 14 (S305).

Further, the collection application 11 provides map information for the disabled such as acquired image information, current location information, and slope information to the collection/analysis device 100 at every set time. Time information at which corresponding information is acquired is included in the image information, the current location information, and the slope information.

The collection/analysis device 100 collect collection information for the disabled received at every set time (S307) and grasps a POI related to the collection information using the GPS coordinates of the collection information (S308). The POI may be grasped by one of the image processing unit 104, the path determination unit 105, and the slope grasping unit 106.

The collection/analysis device 100 classifies received collection information on the basis of the kind (S309), matches received photographing information with GPS coordinates, that is, current location information (S310), and matches slope information with the GPS coordinates (S311). Further, the collection/analysis device 100 continuously accumulates the information processed through the processes S310 and S311 (S312). Such accumulation of information is performed until information collection is finished.

The collection/analysis device 100 determines whether information collection has been finished (S313), and generates a walking path using the current location information (GPS coordinates) accumulated from the start of collection to the end of collection when information collection is finished (S314). Further, when information collection is finished, the collection/analysis device 100 calculates a slope per set unit distance using slope information accumulated from the start of collection to the end of collection, and determines a waling level for the calculated slope per set unit distance (S315). The walking level or the slope determined in this way is reflected to a walking path on the basis of the current location information or time information, and the photographing information is also reflected to the walking path on the basis of the current location information or the time information.

When the walking path including the walking level and the photographing information is generated, the collection/analysis device 100 graphs whether the generated walking path is a valid walking path or a dangerous walking path (S316).

When determining that it is a valid walking path (S317), the collection/analysis device 100 provides the valid walking path to the disabled map generation device 200 as information for a disabled map by matching the valid walking path with a POI (S318). On the contrary, when determining that it is not a valid walking path (S317), the collection/analysis device 100 generates alarm information (S319), matches the valid walking path with a POI together with the generated alarm information, and provides the valid walking path to the disabled map generation device 200 as information for a disabled map (S320).

Although it is described in the embodiment described above that the processes S314 and S315 are performed after information collection is finished, the processes may be performed before information collection is finished.

The collection/analysis device 100 according to an embodiment of the present disclosure described above can easily grasp and provide a valid walking path, which the mobility handicapped such as the disabled can easily use, for an entrance path into a specific building or public facility from the outside.

Further, the collection/analysis device 100 enables the mobility handicapped to know where there is a danger or caution is needed by including information about a danger level or a caution level for an invalid walking path, and enables the mobility handicapped to visually grasp a danger or a caution element where there is a danger or caution is needed, through image information.

FIG. 4 is a flowchart showing an operation method of the map information collection and analysis device for the disabled according to a first embodiment of the present disclosure. A process of starting and finishing information collection is described with reference to FIG. 4.

Referring to FIG. 4, a user at the outside executes the collection application 11 in the user terminal 10 (S401) and connects with the collection/analysis device 100 (S402). In this state, when the user gives an order to perform information transmission start through a menu provided by the collection application 11, the user terminal 10 receives information transmission start (S403) and informs the collection/analysis device 100 of information transmission start (S404).

Accordingly, the collection/analysis device 100 sets a collection mode for information collection (S405). Setting of the collection mode may be performed by the information collecting unit 102 or performed by a controller (not shown) of the collection/analysis device 100.

The user terminal 10 receives GPS information (current location information) through the GPS device 13 (S406) and provides the received GPS information to the collection/analysis device 100 (S407), and the collection/analysis device 100 collects and analyzes map information for the disabled including the received GPS information (S408).

The user terminal 10 grasps whether GPS information is received to grasp whether the user is outside or has entered inside (S409), keeps providing the map information for the disabled when the user is outside and GPS information is received, and displays information transmission end on a screen so that the user knows it when the user is inside and GPS information is not received (S410).

Further, when the user gives an order to perform information transmission end, the user terminal 10 receives the order to perform information transmission end (S410) and informs the collection/analysis device 100 of information transmission end (S411), and the collection/analysis device 100 stops the collection mode (S412). Stopping the collection mode may be performed by the information collecting unit 102 or performed by a controller (not shown) of the collection/analysis device 100.

FIG. 5 is a flowchart showing an operation method of the map information collection and analysis device for the disabled according to a second embodiment of the present disclosure.

Referring to FIG. 5, a user at the outside executes the collection application 11 in the user terminal 10 (S501) and connects with the collection/analysis device 100 (S502). In this state, when acquiring map information for the disabled including GPS information (S503), the user terminal 10 provides the acquired map information for the disabled to the collection/analysis device 100 (S504).

The collection/analysis device 100 sets a collection mode for information collection when receiving map information for the disabled for the first time from the user terminal 10 (S505). Setting of the collection mode may be performed by the information collecting unit 102 or performed by a controller (not shown) of the collection/analysis device 100.

With the collection mode set, when the user terminal 10 receives map information for the disabled including GPS information (current location information) through the GPS device 13 (S506), the user terminal 10 provides the map information for the disabled including GPS information to the collection/analysis device 100 (S507), and the collection/analysis device 100 collects and analyzes the received map information for the disabled including GPS information (S508).

When the user enters inside from the outside, the collection application 11 cannot receive map information for the disabled, and accordingly, the user terminal 10 finishes providing information (S510). Accordingly, the collection/analysis device 100 cannot receive map information for the disabled from the user terminal 10 for a set time (S511), and accordingly, stops the collection mode (S512). Stopping the collection mode may be performed by the information collecting unit 102 or performed by a controller (not shown) of the collection/analysis device 100.

FIG. 6 is a diagram showing the hardware configuration of the map information collection and analysis device for the disabled according to an embodiment of the present disclosure.

The collection/analysis device 100 for the disabled according to an embodiment of the present disclosure shown in FIG. 6 can perform the operations that are performed by the components of the collection/analysis device 100 described with reference to FIGS. 1 to 5.

The collection/analysis device 100 may be a computing device that is operated by at least one processor and can execute a program including instructions written to perform the operations according to the present disclosure.

Referring to FIG. 6, the hardware of the collection/analysis device 100 may include at least one processor 110′, a memory 120′, a storage 130′, and a communication interface 140′, and these components may be connected through communication buses. In addition, the collection/analysis device 100 may further include hardware such as individual input device and output device.

Various items of software including an operating system that can drive programs may be installed in a storage device such as the storage 130′ in the collection/analysis device 100. The processor 110′, which is a device controlling the operation of the device 100′, may be various types of processors that processes instructions included in a program (e.g., a CPU (Central Processing Unit), an MPU (Micro Processor Unit), an MCU (Micro Controller Unit), and a GPU (Graphic Processing Unit)).

The memory 120′ can load a corresponding program so that instructions written to perform the operations according to the present disclosure are processed by the processor 110′. For example, the memory 120′ may be a ROM (Read Only Memory), an RAM (Random Access Memory), etc.

The storage 130′ can store various data, programs, etc. required to perform the operations according to the present disclosure. A database may be included in a region of the storage 130′.

The communication interface 140′ may be a wire/wireless communication module that processes communication among the components of the device 100 and communication with an external linked device. The communication interface 140′ may correspond to the communication unit 110 described with reference to FIG. 2.

Meanwhile, setting and stopping the collection mode in the embodiment described above may be performed by the information collecting unit 120 or may be performed by a controller (not shown) of the collection/analysis device 100.

The above description is intended to provide exemplary components and operations for achieving the present disclosure. The spirit of the present disclosure may include not only the embodiments described above, but also configurations that can be obtained by simply changing or modifying the embodiments. Further, the spirit of the present disclosure may include configurations that can be achieved by easily changing or modifying the embodiments described above.

According to an embodiment, the present disclosure collects in real time walking information for entering a corresponding building or facility from a user terminal positioned at a building or a public facility and analyzes the collecting walking information on the side of the mobility handicapped so that the information can be reflected to a map, thereby being able to easily and conveniently make a map for the mobility handicapped using information provided from several common users at various places in the whole country.

According to an embodiment of the present disclosure, it is possible to easily grasp and provide a valid walking path, which the mobility handicapped such as the disabled can easily use, for an entrance path into a specific building or public facility from the outside, and enable the handicapped to easily grasp a reason for an invalid walking path.

What is claimed is:

1. A map information collection and analysis device for the disabled, comprising:
a user interface functioning as a communication interface with a user terminal;
an information collecting unit collecting map information for the disabled received from each user terminal through the user interface;
an information classification unit classifying the map information for the disabled into image information, current location information, and slope information;
an image processing unit matching the image information and the current location received from the information classifying unit on the basis of same time;
a path determination unit grasping and determining a movement path of a corresponding user terminal by tracking the current location information received from the information classification unit on the basis of time;
a slope grasping unit calculating a movement distance using the current location information received from the information classifying unit, and calculating a slope per set unit distance using the calculated movement distance and slope information received from the information classifying unit;
a walking convenience analysis unit determining a walking level using the slope per set unit distance received from the slope grasping unit; and
a map information generating unit grasping a POI of a place where a user is currently positioned by applying the received current location information to map information of a database, and generating disabled path information using a first path received from the path determination unit, a first image received from the image processing unit, and the walking level received from the slope grasping unit,
wherein the map information for the disabled is information provided from one user terminal and includes slope information measured by a slope sensor of the user terminal, image information photographed by a camera of the user terminal, and current location information measured by a GPS device of the user terminal.

2. The map information collection and analysis device for the disabled of claim 1, wherein the walking convenience analysis unit determines a wheelchair available level when the slope per set unit distance is less than a first angle, determines a caution level requiring attention to moving a wheelchair when the slope per set unit distance is the first angle or more, and determines a wheelchair unavailable level when the slope per set unit distance is a second angle or more that is larger than the first angle.

3. The map information collection and analysis device for the disabled of claim 2, wherein the map information generating unit determines the first path as a valid walking path when all of a plurality of slopes per set unit distance included in the first path are less than the first angle.

4. The map information collection and analysis device for the disabled of claim 1, wherein the information collecting unit performs an information collection operation for a first user terminal by operating when current location information is initially received from the first user terminal, and stops the information collection operation for the first user terminal when current location information is not received from the first user terminal.

5. The map information collection and analysis device for the disabled of claim 2, wherein the information collecting unit performs an information collection operation for a first user terminal by operating when current location information is initially received from the first user terminal, and stops the information collection operation for the first user terminal when current location information is not received from the first user terminal.

6. The map information collection and analysis device for the disabled of claim 1, wherein the information collecting unit performs an information collection operation for a first user terminal when an information transmission start order is received from the first user terminal, and stops the information collection operation for the first user terminal when an information transmission end order is received from the first user terminal.

7. The map information collection and analysis device for the disabled of claim 2, wherein the information collecting unit performs an information collection operation for a first user terminal when an information transmission start order is received from the first user terminal, and stops the information collection operation for the first user terminal when an information transmission end order is received from the first user terminal.
